(19) United States
(12) Patent Application Publication
(10) Pub. No.: US 2026/0289397 A1
(43) Pub. Date: Sep. 24, 2026

(54) METHOD AND APPARATUS FOR TRAINING ARTIFICIAL INTELLIGENCE/MACHINE LEARNING MODELS AT SINGLE ENTITY

(71) Applicant: MEDIATEK INC., Hsinchu City (TW)

(72) Inventors: Pedram KHEIRKHAH SANGDEH, San Jose, CA (US); Shiauhe TSAI, San Jose, CA (US); Gyu Bum KYUNG, San Jose, CA (US)

(21) Appl. No.: 19/165,998

(22) PCT Filed: May 16, 2024
(86) PCT No.: PCT/CN2024/093563

§ 371 Date: Sep. 16, 2025

Related U.S. Application Data
(60) Provisional application No. 63/502,424, filed on May 16, 2023.

(51) Int. Cl. G06N 20/00

(52) U.S. Cl. CPC G06N 20/00

(57) ABSTRACT

Techniques pertaining to training artificial intelligence and machine learning (AI/ML) models at a single entity in wireless communications are described. A network trains a two-sided AI/ML model of one or more types and provides the two-sided AI/ML model of the one or more types to one or more user equipment (UE) devices. A UE device requests the network for a two-sided AI/ML model for deployment and receives, from the network, the two-sided AI/ML model of one or more types depending on information contained in the request.

### CROSS REFERENCE TO RELATED PATENT APPLICATION(S)

The present disclosure claims the priority benefit of U.S. Provisional Patent Application No. 63/502,424, filed 16 May 2023, the content of which being herein incorporated by reference in its entirety.

### TECHNICAL FIELD

The present disclosure is generally related to wireless communications and, more particularly, to training artificial intelligence and machine learning (AI/ML) models at a single entity in wireless communications.

### BACKGROUND

Unless otherwise indicated herein, approaches described in this section are not prior art to the claims listed below and are not admitted as prior art by inclusion in this section.

In a communication system, such as wireless communications in accordance with the 3^{rd} Generation Partnership Project (3GPP) standards, many functions on the user equipment (UE) side tend to have a corresponding twin on the network side, and vice versa. In the context of AI/ML, this may be referred to as a two-sided AI/ML model, also known as autoencoders. For example, for a modulation function at the UE/network there is a demodulation function at the network/UE, for a quantization function at the UE/network there is a dequantization function at the network/UE, for a forward error correction (FEC) encoder at the UE/network there is a decoder at the network/UE, and for a signal shaper function at the UE/network there is a de-shaper at the network/UE, and vice versa. There are also functions/applications that need complimentary modules at both the UE and network such as, for example, channel state information (CSI) compression, denoising (or noise reduction), quantization, coding, error correction codes, modulation, peak-to-average power ratio (PAPR) reduction, and image compression. In short, in a two-sided AI/ML model, it is most ideal to train both sides together so that the function on one side is compatible with the corresponding function on the other side.

In the context of CSI, CSI compression is a study item (SI) in the 5^{th} Generation (5G) New Radio (NR) Release 18 specification regarding air interface. In the two-sided autoencoder-based AI/ML models, the UE (encoder/CSI construction) of a two-sided AI/ML translates CSI into a compressed representation, and the network (decoder/CSI reconstruction) reconstructs the CSI from its compressed representation.

With respect to training of AI/ML models in wireless communication systems, there may be several training stages at a single entity (e.g., the UE or a network node of the network). Initially, a desired architecture of encoder and decoder for two-sided AI/ML models need to be designed. Then, both sides need to be trained through a forward pass (FP) and backpropagation (BP). In FP, the encoder passes encoded information (e.g., latent vector) to the decoder, and the decoder recovers the information. In BP, reconstruction error is calculated and its gradient with respect to parameters may propagate through the encoder and decoder for updates to the parameters. Lastly, performance of the two-sided AI/ML model as a whole needs to be verified.

In Training Type 1, which involves joint training at a single entity (whether on the UE side or the network side), the training entity (UE or network) at a training stage trains a two-sided AI/ML model in a single training session and through individual FP and BP loops. Then, at an inference stage, a non-training entity would request the training entity to provide its corresponding part (e.g., an encoder for a UE vender and a decoder for a network vendor), and the non-training entity would download its corresponding part of the two-sided AI/ML model for a certain task (e.g., CSI compression).

There are pros and cons associated with Training Type 1. In terms of pros, as both encoder and decoder are trained at a single entity, the performance can be guaranteed. Additionally, as both encoder and decoder are designed by the single entity, a matched architecture can be used. Besides, discrepancy between input type and output type, between quantizer and dequantizer, and between pre-processing and post-processing can be avoided, thereby achieving alignment. Moreover, efforts in development, training, re-training, fine-tuning, and monitoring of AI/ML models can be concentrated in the single entity. However, in terms of cons, the AI/ML model tends to be not optimized for other non-training entities. This can be especially challenging if the network trains a single encoder and provides AI/ML model(s) to UEs with tight computation and storage budgets. Therefore, there is a need for a solution of training AI/ML models at a single entity in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to training AI/ML models at a single entity in wireless communications. It is believed that implementations of the various proposed schemes may address or otherwise alleviate the aforementioned issue(s).

In one aspect, a method may involve a processor of an apparatus training a two-sided AI/ML model of one or more types. The method may also involve the processor providing the two-sided AI/ML model of the one or more types to one or more UE devices.

In another aspect, a method may involve a processor of an apparatus requesting a network for a two-sided AI/ML model for deployment. The method may also involve the processor receiving, from the network, the two-sided AI/ML model of one or more types depending on information contained in the request.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a block diagram of an example communication system under a proposed scheme in accordance with the present disclosure.

FIG. 6 is a flowchart of an example process under a proposed scheme in accordance with the present disclosure.

FIG. 7 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to training AI/ML models at a single entity in wireless communications. According to the present disclosure, a number of possible solutions may be implemented separately or jointly. That is, although these possible solutions may be described below separately, two or more of these possible solutions may be implemented in one combination or another.

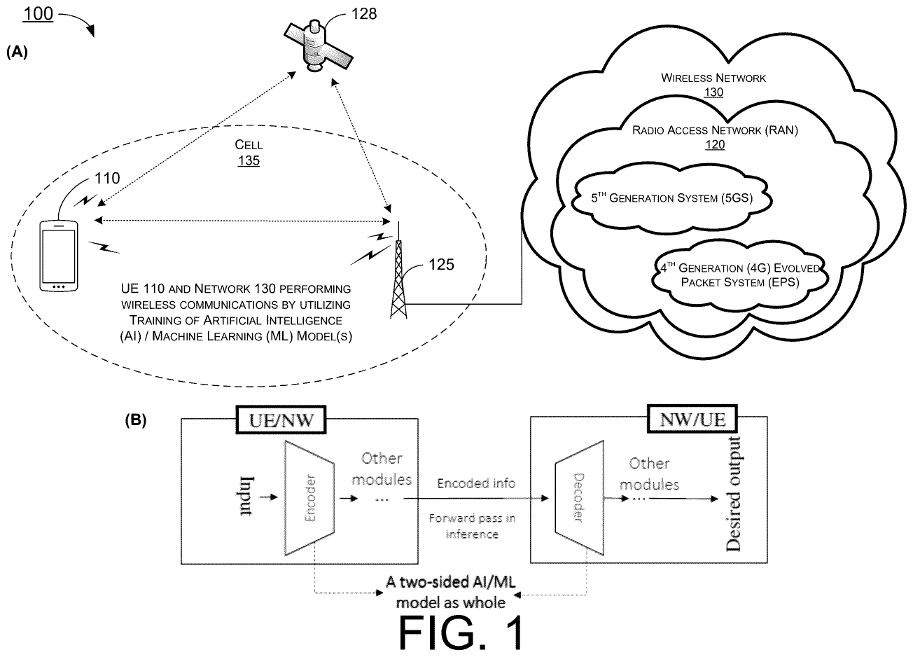

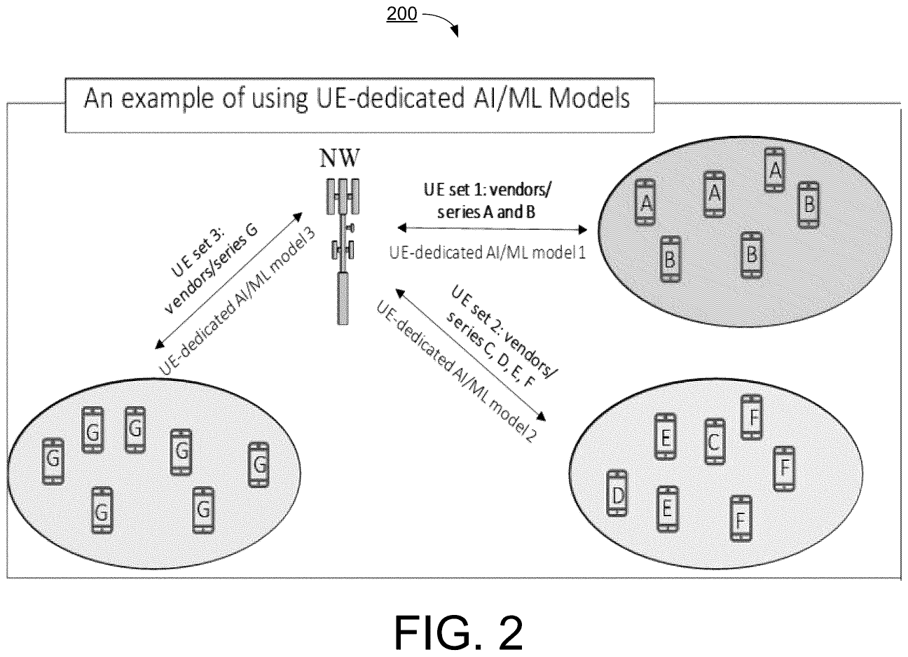

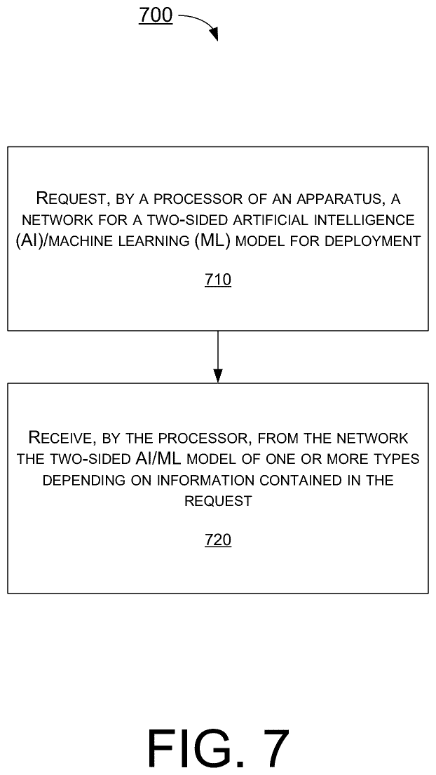

FIG. 1 illustrates an example network environment 100 in which various solutions and schemes in accordance with the present disclosure may be implemented. FIG. 2~FIG. 7 illustrate examples of implementation of various proposed schemes in network environment 100 in accordance with the present disclosure. The following description of various proposed schemes is provided with reference to FIG. 1~FIG. 7.

Referring to part (A) of FIG. 1, network environment 100 may involve a UE 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a wireless network 130. In network environment 100, UE 110 and wireless network 130 (via terrestrial network node 125 and/or non-terrestrial network node 128) may implement various schemes pertaining to training AI/ML models at a single entity in wireless communications, as described below. Part (B) of FIG. 1 shows an example of a two-sided AI/ML model as a whole implemented at a UE, such as UE 110, and a network (NW), such as terrestrial network node 125 and/or non-terrestrial network node 128. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

In a heterogeneous wireless ecosystem, UEs provided by different vendors may have different computation and storage budgets, resulting in heterogeneous UE capabilities. Besides, even the UEs made by the same vendor may have different capabilities that vary from one device to another. On the other hand, network nodes may have different computational and storage budgets, although this may not be a major challenge as networks are expected to access large computation and storage resources. However, there may still be a challenge with network-side Training Type 1. That is, if a network (e.g., wireless network 130) trains AI/ML models regardless of specifications of UEs, deployment of such models may not be feasible at the inference stage. For instance, a given AI/ML model may need excessive storage that a UE cannot afford. Moreover, the AI/ML model may need excessive computations that may cause significant intolerable latency.

In view of the above, under a first proposed scheme in accordance with the present disclosure, dedicated AI/ML models may be trained and provided by a network to heterogeneous UE devices. For instance, a network (e.g., wireless network 130) may train a specific AI/ML model (herein interchangeably referred to as a “UE-dedicated AI/ML model”) for one or multiple kids of UE devices. Consequently, feasibility of deployment may be guaranteed, and inference latency may be guaranteed. Under the first proposed scheme, the network may train multiple dedicated AI/ML models.

FIG. 2 illustrates an example scenario 200 under the first proposed scheme in accordance with the present disclosure. Scenario 200 may pertain to an example of using dedicated AI/ML models. Referring to FIG. 2, a network may train multiple dedicated AI/ML models. For instance, a network (e.g., wireless network 130) may train and provide a dedicated AI/ML model 1 to a first set of UE (UE set 1) including UE devices of series A and B (or from vendors A and B). Additionally, the network may train and provide a dedicated AI/ML model 2 to a second set of UE (UE set 2) including UE devices of series C, D, E and F (or from vendors C, D, E and F). Moreover, the network may train and provide a dedicated AI/ML model 3 to a third set of UE (UE set 3) including UE devices of series G (or from vendor G).

Under a second proposed scheme in accordance with the present disclosure, non-dedicated AI/ML models may be trained and provided by a network to heterogeneous UE devices. Under the proposed scheme, non-dedicated AI/ML models may be designed and trained by a network without targeting any specific type of UE devices. For instance, the network (e.g., wireless network 130) may train a universal AI/ML model to serve all UEs regardless of the vendors, types and/or capabilities of the UE devices. Hence, there may be no guarantee on the feasibility of deployment and latency, and the universal AI/ML model may only work for a subset of UE devices. Under the proposed scheme, multiple non-dedicated models may be trained and provided to heterogeneous UE devices. For instance, to embrace heterogeneity of UE capabilities, the network may train a range of AI/ML models to cater to UEs with different capabilities such as computation and storage budgets.

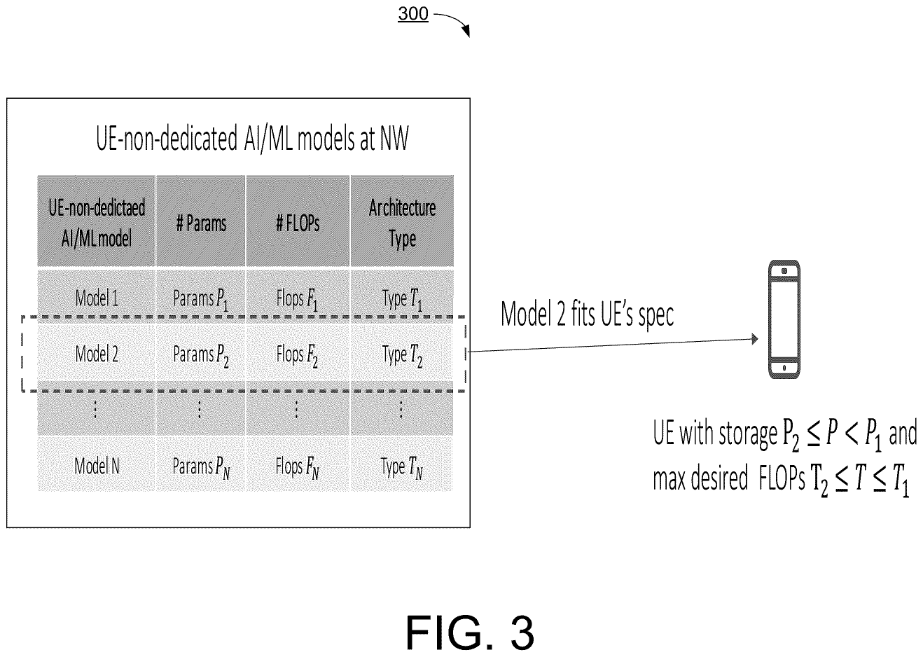

FIG. 3 illustrates an example scenario 300 under the second proposed scheme in accordance with the present disclosure. Scenario 300 may pertain to an example of training of non-dedicated AI/ML models. Referring to FIG. 3, a network (e.g., wireless network 130) may train a range of non-dedicated AI/ML models such as Model 1, Model 2, . . . Model N. The various models may correspond to respective parameters, flops and architecture types. As shown in FIG. 3, the non-dedicated AI/ML models of Model 1, Model 2, . . . Model N may correspond to parameters P₁, P₂, . . . P_{N}, flops F₁, F₂, . . . , F_{N}, and architecture types T₁, T₂, . . . T_{N}, respectively. Furthermore, as shown in FIG. 3, in an event that a certain model (e.g., Model 2) fits the specification of a UE device (e.g., UE 110), such as storage P (with P₂≤P≤P₁) and maximum desired flops T (with T₂≤T≤T₁), Model 2 may be provided to that UE device.

Under a third proposed scheme in accordance with the present disclosure, there may be different types of requests and responses regarding AI/ML model deployment. For example, with general requests and responses, a UE device (e.g., UE 110) may not specify its desired dedicated AI/ML model nor its computation and storage budgets. In response, a network (e.g., wireless network 130) may send a universal AI/ML model or a low-complexity non-dedicated AI/ML model to the UE device. As another example, with dedicated requests and responses, the UE device may specify its dedicated AI/ML model in its request to the network. In response, the network may send the UE device a dedicated AI/ML model as requested. As still another example, with non-dedicated requests and responses, the UE device may specify its storage and computation budgets in its request to the network. In response, the network may send the UE device a non-dedicated AI/ML model that fits the UE device's computation and storage budgets.

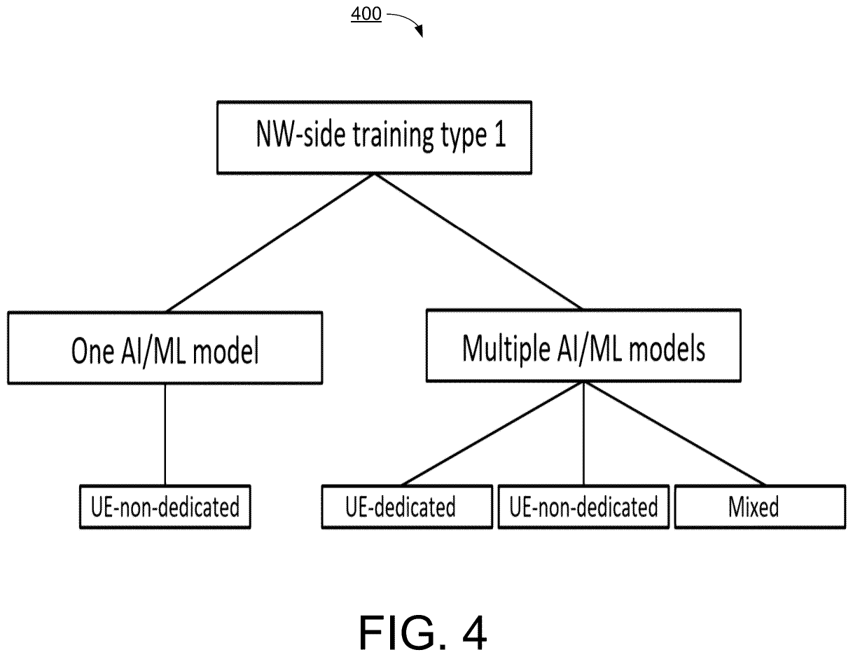

Under a fourth proposed scheme in accordance with the present disclosure, there may be different types of AI/ML models obtained from Training Type 1 at the network. FIG. 4 illustrates an example scenario 400 under the fourth proposed scheme in accordance with the present disclosure. Scenario 400 may pertain to an example of different types of AI/ML models obtained from Training Type 1. Referring to FIG. 4, a network (e.g., wireless network 130) may train and offer different types of AI/ML models including, for example: (1) one universal AI/ML model, (2) multiple dedicated AI/ML models, (3) multiple non-dedicated AI/ML models, and (4) a mixture of multiple dedicated and non-dedicated AI/ML models.

### Illustrative Implementations

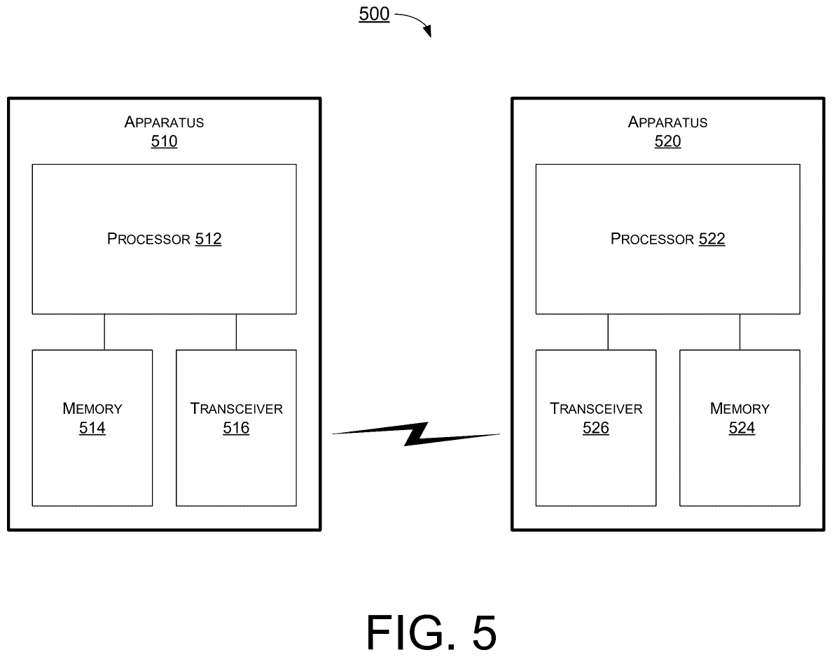

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 510 and apparatus 520 may be a part of an electronic apparatus, which may be a network apparatus or a UE device (e.g., UE 110), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNodeB in an LTE, LTE-Advanced or LTE-Advanced Pro network or in a gNB or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to training AI/ML models at a single entity in wireless communications in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as a UE device (e.g., UE 110), and apparatus 520, as a network node (e.g., network node 125) of a network (e.g., network 130 as a 5G/NR mobile network), is provided below in the context of example processes 600 and 700.

### Illustrative Processes

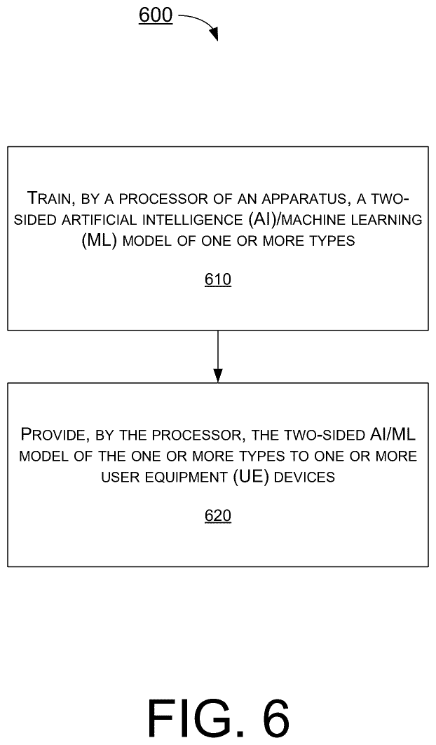

FIG. 6 illustrates an example process 600 in accordance with an implementation of the present disclosure. Process 600 may represent an aspect of implementing various proposed designs, concepts, schemes, systems and methods described above pertaining to training AI/ML models at a single entity in wireless communications, whether partially or entirely, including those pertaining to those described above. Process 600 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 600 may be implemented by or in apparatus 510 and/or apparatus 520 as well as any variations thereof. Solely for illustrative purposes and without limiting the scope, each process is described below in the context of apparatus 510 as a UE device (e.g., UE 110) and apparatus 520 as a communication entity such as a network node or base station (e.g., terrestrial network node 120) of a network (e.g., a 5G/NR mobile network). Process 600 may begin at block 610.

At 610, process 600 may involve processor 522 of apparatus 520 (e.g., as terrestrial network node 125 or non-terrestrial network node 128 of wireless network 130) training a two-sided AI/ML model of one or more types. Process 600 may proceed from 610 to 620.

At 620, process 600 may involve processor 522 providing, via transceiver 526, the two-sided AI/ML model of the one or more types to one or more UE devices (e.g., including apparatus 510).

In some implementations, in providing the two-sided AI/ML model of the one or more types, process 600 may involve processor 522 providing the two-sided AI/ML model of the one or more types to different UE devices of different computation and storage capabilities.

In some implementations, in training the two-sided AI/ML model of the one or more types, process 600 may involve processor 522 training one or more UE-dedicated AI/ML models each of which targeting one or more types of UE devices.

In some implementations, in training the two-sided AI/ML model of the one or more types, process 600 may involve processor 522 training one or more non-dedicated AI/ML models.

In some implementations, in training the one or more non-dedicated AI/ML models, process 600 may involve processor 522 training a universal AI/ML model to serve a plurality of UE devices without regards to vendors, types or capabilities of the plurality of UE devices.

In some implementations, in training the one or more non-dedicated AI/ML models, process 600 may involve processor 522 training multiple non-dedicated AI/ML models to serve a plurality of UE devices without targeting any specific type of the UE devices. In some implementations, each of the multiple non-dedicated AI/ML models may correspond to one or more of a respective parameter, a respective flop, and a respective architecture type associated with one or more UE devices of the plurality of UE devices.

In some implementations, in training the two-sided AI/ML model of the one or more types, process 600 may involve processor 522 performing certain operations. For instance, process 600 may involve processor 522 training one or more UE-dedicated AI/ML models each of which targeting one or more types of UE devices. Additionally, process 600 may involve processor 522 training one or more non-dedicated AI/ML models. In some implementations, in training the one or more non-dedicated AI/ML models, process 600 may involve processor 522 training a universal AI/ML model to serve a plurality of UE devices without regards to vendors, types or capabilities of the plurality of UE devices. In some implementations, in training the one or more non-dedicated AI/ML models, process 600 may involve processor 522 training multiple non-dedicated AI/ML models to serve a plurality of UE devices without targeting any specific type of the UE devices. In some implementations, each of the multiple non-dedicated AI/ML models may correspond to one or more of a respective parameter, a respective flop, and a respective architecture type associated with one or more UE devices of the plurality of UE devices.

In some implementations, in providing the two-sided AI/ML model of the one or more types, process 600 may involve processor 522 performing certain operations. For instance, process 600 may involve processor 522 receiving, from a UE device of the one or more UE devices, a request without specifying a desired dedicated AI/ML model or a computation and storage budget of the UE device. Moreover, process 600 may involve processor 522 providing a universal AI/ML model or a low-complexity non-dedicated AI/ML model to the UE device.

Alternatively, in providing the two-sided AI/ML model of the one or more types, process 600 may involve processor 522 performing certain operations. For instance, process 600 may involve processor 522 receiving, from a UE device of the one or more UE devices, a request specifying a desired dedicated AI/ML model. Moreover, process 600 may involve processor 522 providing a dedicated AI/ML model to the UE device.

Still alternatively, in providing the two-sided AI/ML model of the one or more types, process 600 may involve processor 522 performing certain operations. For instance, process 600 may involve processor 522 receiving, from a UE device of the one or more UE devices, a request specifying a computation and storage budget of the UE device. Furthermore, process 600 may involve processor 522 providing a non-dedicated AI/ML model to the UE device. In some implementations, the non-dedicated AI/ML model may fit the computation and storage budget of the UE device.

FIG. 7 illustrates an example process 700 in accordance with an implementation of the present disclosure. Process 700 may represent an aspect of implementing various proposed designs, concepts, schemes, systems and methods described above pertaining to training AI/ML models at a single entity in wireless communications, whether partially or entirely, including those pertaining to those described above. Process 700 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 700 may be implemented by or in apparatus 510 and/or apparatus 520 as well as any variations thereof. Solely for illustrative purposes and without limiting the scope, each process is described below in the context of apparatus 510 as a UE device (e.g., UE 110) and apparatus 520 as a communication entity such as a network node or base station (e.g., terrestrial network node 120) of a network (e.g., a 5G/NR mobile network). Process 700 may begin at block 710.

At 710, process 700 may involve processor 512 of apparatus 510 (e.g., as UE 110) requesting, via transceiver 516, a network (e.g., via apparatus 520 as terrestrial network node 125 or non-terrestrial network node 128) for a two-sided AI/ML model for deployment. Process 700 may proceed from 710 to 720.

At 720, process 700 may involve processor 512 receiving, via transceiver 516, from the network the two-sided AI/ML model of one or more types depending on information contained in the request.

In some implementations, in receiving the two-sided AI/ML model of the one or more types, process 700 may involve processor 512 receiving a universal AI/ML model or a low-complexity non-dedicated AI/ML model responsive to the request not specifying a desired dedicated AI/ML model or a computation and storage budget of the UE device.

Alternatively, in receiving the two-sided AI/ML model of the one or more types, process 700 may involve processor 512 receiving a dedicated AI/ML model to the UE device responsive to the request specifying a desired dedicated AI/ML model.

Still alternatively, in receiving the two-sided AI/ML model of the one or more types, process 700 may involve processor 512 receiving a non-dedicated AI/ML model to the UE device responsive to the request specifying a computation and storage budget of the UE device. In some implementations, the non-dedicated AI/ML model may fit the computation and storage budget of the UE device.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method implemented on a network side, comprising:
training, by a processor of an apparatus, a two-sided artificial intelligence (AI)/machine learning (ML) model of one or more types; and
providing, by the processor, the two-sided AI/ML model of the one or more types to one or more user equipment (UE) devices.

2. The method of claim 1, wherein the providing of the two-sided AI/ML model of the one or more types comprises providing the two-sided AI/ML model of the one or more types to different UE devices of different computation and storage capabilities.

3. The method of claim 1, wherein the training of the two-sided AI/ML model of the one or more types comprises training one or more UE-dedicated AI/ML models each of which targeting one or more types of UE devices.

4. The method of claim 1, wherein the training of the two-sided AI/ML model of the one or more types comprises training one or more non-dedicated AI/ML models.

5. The method of claim 4, wherein the training of the one or more non-dedicated AI/ML models comprises training a universal AI/ML model to serve a plurality of UE devices without regards to vendors, types or capabilities of the plurality of UE devices.

6. The method of claim 4, wherein the training of the one or more non-dedicated AI/ML models comprises training multiple non-dedicated AI/ML models to serve a plurality of UE devices without targeting any specific type of the UE devices.

7. The method of claim 6, wherein each of the multiple non-dedicated AI/ML models corresponds to one or more of a respective parameter, a respective flop, and a respective architecture type associated with one or more UE devices of the plurality of UE devices.

8. The method of claim 1, wherein the training of the two-sided AI/ML model of the one or more types comprises:
training one or more UE-dedicated AI/ML models each of which targeting one or more types of UE devices; and
training one or more non-dedicated AI/ML models.

9. The method of claim 8, wherein the training of the one or more non-dedicated AI/ML models comprises training a universal AI/ML model to serve a plurality of UE devices without regards to vendors, types or capabilities of the plurality of UE devices.

10. The method of claim 8, wherein the training of the one or more non-dedicated AI/ML models comprises training multiple non-dedicated AI/ML models to serve a plurality of UE devices without targeting any specific type of the UE devices.

11. The method of claim 10, wherein each of the multiple non-dedicated AI/ML models corresponds to one or more of a respective parameter, a respective flop, and a respective architecture type associated with one or more UE devices of the plurality of UE devices.

12. The method of claim 1, wherein the providing of the two-sided AI/ML model of the one or more types comprises:
receiving, from a UE device of the one or more UE devices, a request without specifying a desired dedicated AI/ML model or a computation and storage budget of the UE device; and
providing a universal AI/ML model or a low-complexity non-dedicated AI/ML model to the UE device.

13. The method of claim 1, wherein the providing of the two-sided AI/ML model of the one or more types comprises:
receiving, from a UE device of the one or more UE devices, a request specifying a desired dedicated AI/ML model; and
providing a dedicated AI/ML model to the UE device.

14. The method of claim 1, wherein the providing of the two-sided AI/ML model of the one or more types comprises:
receiving, from a UE device of the one or more UE devices, a request specifying a computation and storage budget of the UE device; and
providing a non-dedicated AI/ML model to the UE device.

15. The method of claim 14, wherein the non-dedicated AI/ML model fits the computation and storage budget of the UE device.

16. A method implemented on a user equipment (UE) side, comprising:
requesting, by a processor of an apparatus, a network for a two-sided artificial intelligence (AI)/machine learning (ML) model for deployment; and
receiving, by the processor, from the network the two-sided AI/ML model of one or more types depending on information contained in the request.

17. The method of claim 16, wherein the receiving of the two-sided AI/ML model of the one or more types comprises receiving a universal AI/ML model or a low-complexity non-dedicated AI/ML model responsive to the request not specifying a desired dedicated AI/ML model or a computation and storage budget of the UE device.

18. The method of claim 16, wherein the receiving of the two-sided AI/ML model of the one or more types comprises receiving a dedicated AI/ML model to the UE device responsive to the request specifying a desired dedicated AI/ML model.

19. The method of claim 16, wherein the receiving of the two-sided AI/ML model of the one or more types comprises receiving a non-dedicated AI/ML model to the UE device responsive to the request specifying a computation and storage budget of the UE device.

20. The method of claim 19, wherein the non-dedicated AI/ML model fits the computation and storage budget of the UE device.
